(19) United States
(12) Patent Application Publication
(10) Pub. No.: US 2006/0237072 A1
(43) Pub. Date: Oct. 26, 2006

(54) Tubular fitment for lavatory facility

(76) Inventor: Lien Hung Lee, Taipei Hsien (TW)

Correspondence Address: CHARLES E. BAXLEY, ESQ., 90 JOHN STREET, THIRD FLOOR, NEW YORK, NY, 10038, US

(21) Appl. No.: 11/034,998

(22) Filed: Jan. 12, 2005

(51) Int. Cl. F16K 21/00

(52) U.S. Cl. 137/801

(57) ABSTRACT

A lavatory facility includes a faucet for attaching to a lavatory member and having a base member for engaging onto the lavatory member, and a tubular fitment for attaching the faucet to the lavatory member. The tubular fitment includes a shank having one end for engaging into the faucet, and a peripheral rib for engaging with and for anchoring the shank to the faucet. The shank includes a peripheral flange for engaging with the base member of the faucet, and for anchoring the shank to the faucet and the lavatory member. A pipe includes a bore for receiving the shank, and includes an inner thread for threading with an outer thread of the shank, and for securing the pipe to the shank, and for securing the faucet to the lavatory member having different heights or thicknesses or depths.

### BACKGROUND OF THE INVENTION

1. Field of the Invention

The present invention relates to a tubular fitment, and more particularly to a tubular fitment for easily and readily attached to lavatory facilities having different heights or thicknesses or depths.

2. Description of the Prior Art

Various kinds of typical tubular fitments have been developed and provided for attaching valves or faucets to lavatory facilities, such as sinks, basins, bath tubs, etc., and comprise a primary elongate tubular member for engaging through the lavatory facilities, and one or more fasteners or nuts threaded onto the primary elongate tubular member, for solidly securing the primary elongate tubular member to the lavatory facilities.

For example, U.S. Pat. No. 4,324,423 to Pitesky discloses one of the typical tubular fitments capable of establishing a fluid tight passage defining a connection between two confined space defining means, and comprising a primary elongate tubular member for engaging through the lavatory facilities, and for solidly securing to the lavatory facilities with one or more fasteners or nuts. However, a number of elements or fasteners are required to secure the primary elongate tubular member to the lavatory facilities. In addition, it will be inconvenient to secure the primary elongate tubular member to the lavatory facilities having different heights or thicknesses or depths.

U.S. Pat. No. 6,079,061 to Fan discloses a diversion device for securing between a faucet and a shower head, and also comprising an elongate tubular member for engaging through and for securing to the lavatory facilities with fasteners or nuts. However, similarly, a number of elements or fasteners are required to secure the primary elongate tubular member to the lavatory facilities. In addition, it will be inconvenient to secure the primary elongate tubular member to the lavatory facilities having different heights or thicknesses or depths.

U.S. Pat. No. 6,467,104 to Shieh discloses a faucet assembly having an attachable sprayer nozzle, and also comprising an elongate tubular member for engaging through and for securing to the lavatory facilities with fasteners or nuts. However, similarly, a number of elements or fasteners are required to secure the primary elongate tubular member to the lavatory facilities. In addition, it will be inconvenient to secure the primary elongate tubular member to the lavatory facilities having different heights or thicknesses or depths.

The present invention has arisen to mitigate and/or obviate the afore-described disadvantages of the conventional tubular fitments for lavatory facilities.

### SUMMARY OF THE INVENTION

The primary objective of the present invention is to provide a tubular fitment for readily attached to lavatory facilities having different heights or thicknesses or depths.

In accordance with one aspect of the invention, there is provided a lavatory facility comprising a lavatory member, a faucet for attaching to the lavatory member, the faucet including a base member for engaging onto the lavatory member, and including a chamber formed therein, and a tubular fitment for attaching the faucet to the lavatory member. The tubular fitment includes an elongate shank having a first end for engaging into the chamber of the faucet, and having at least one sealing ring engaged onto the first end thereof, and engaged between the faucet and the control shank, for making a water tight seal between the faucet and the shank, the shank includes a peripheral rib extended radially and outwardly therefrom, for engaging with the faucet, and for anchoring the shank to the faucet, the shank includes a peripheral flange extended radially and outwardly therefrom, and spaced away from the peripheral rib thereof, for engaging with the base member of the faucet, and for anchoring the shank to the faucet and the lavatory member, the shank includes an outer thread formed thereon and includes a second end having at least one sealing ring engaged thereon. A pipe includes a bore formed therein for receiving the second end of the shank, and includes a first end having an inner thread formed therein, for threading with the outer thread of the shank, and for securing the pipe to the shank.

The pipe includes a peripheral flap extended radially and outwardly from the first end thereof, for engaging with the lavatory member. The faucet includes a control shank slidably engaged through the chamber thereof, and a sealing ring engaged between the faucet and the control shank, for making a water tight seal between the faucet and the control shank.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial cross sectional view showing a lavatory facility having a tubular fitment in accordance with the present invention;

FIG. 2 is a partial exploded and cross sectional view of the tubular fitment for lavatory facilities;

FIG. 3 is a partial cross sectional view of the tubular fitment for lavatory facilities;

FIG. 4 is a partial cross sectional view illustrating the operation of the tubular fitment for lavatory facilities;

FIG. 5 is a partial cross sectional view similar to FIG. 4, illustrating the attachment of the tubular fitment to the lavatory facilities having different heights or thicknesses or depths; and

FIG. 6 is a partial cross sectional view similar to FIG. 1, illustrating the other arrangement of the tubular fitment for lavatory facilities.

### DETAILED DESCRIPTION OF THE PREFERRED EMBODIMENT

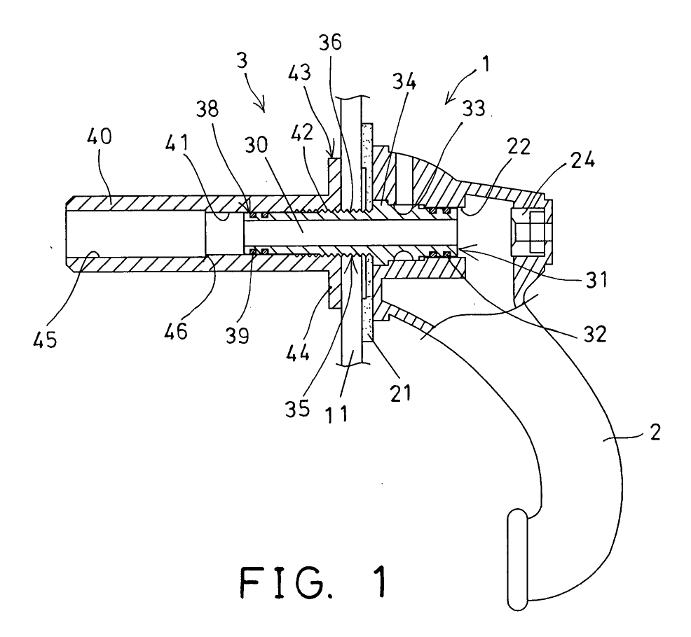

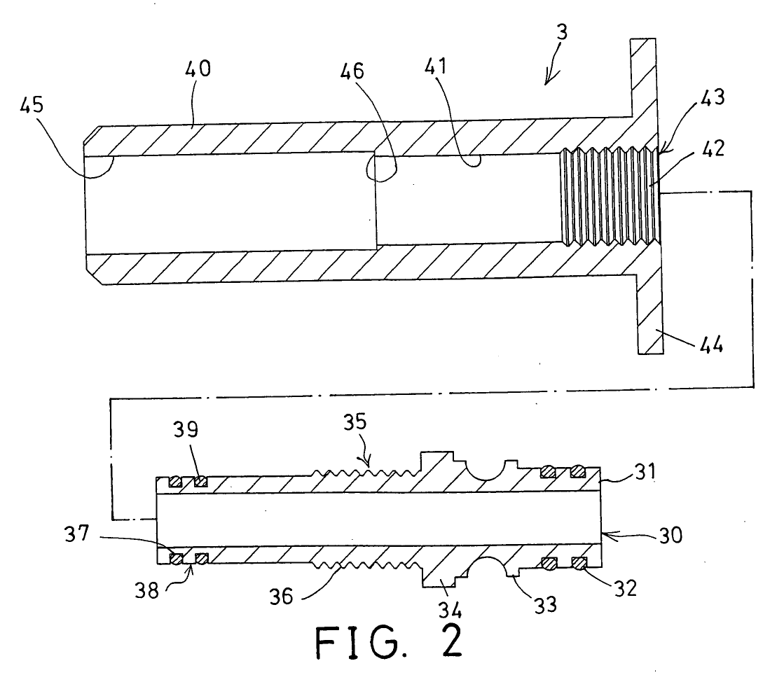

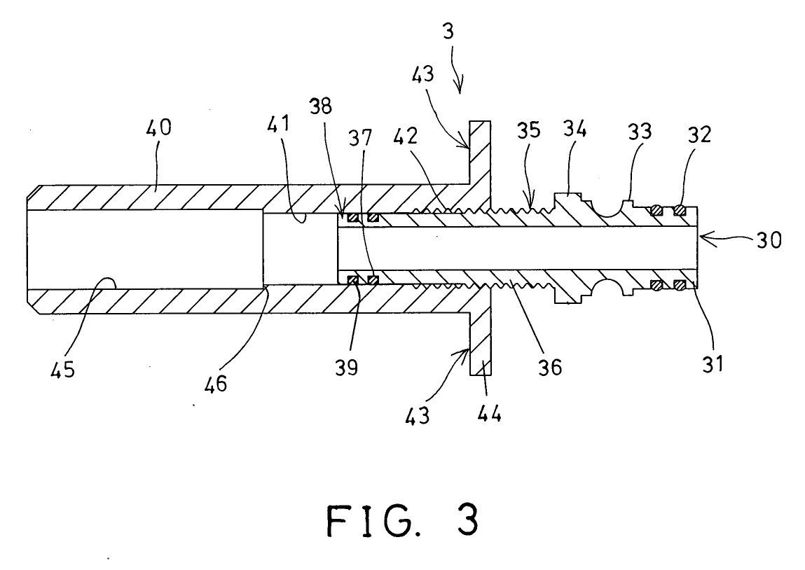

Referring to the drawings, and initially to FIGS. 1-3, a lavatory facility 1 in accordance with the present invention comprises a lavatory member 11, such as sink, basins, bath tub, etc., and a valve or faucet 2 for attaching to the lavatory member 11. The valve or faucet 2 includes a base portion or member 21 for engaging or attaching onto the lavatory member 11 (FIGS. 1 and 4-6), and includes a chamber 22 formed therein, a control shank 23 slidably engaged through the chamber 22 thereof, and a gasket or sealing ring 24 engaged between the faucet 2 and the control shank 23, for making a water tight seal between the faucet 2 and the control shank 23, for example.

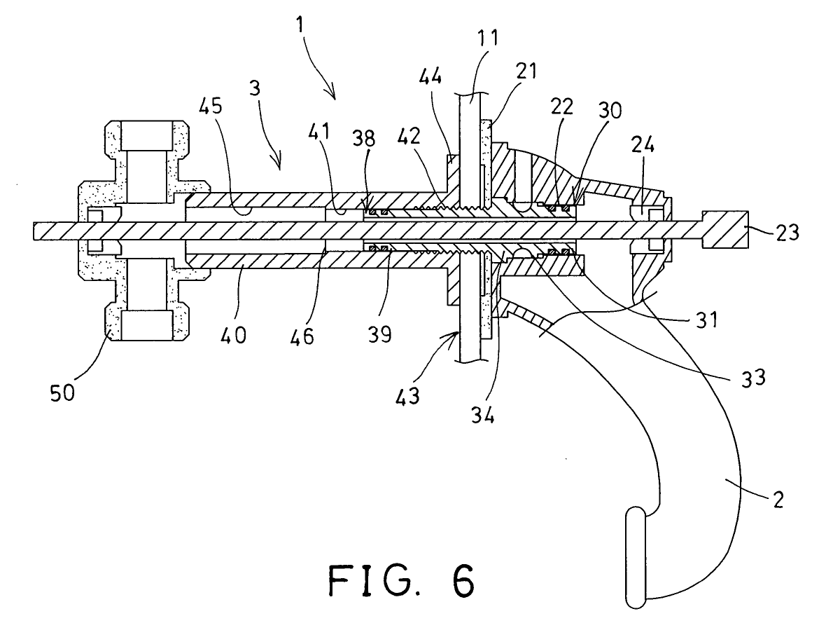

The lavatory facility 1 includes a tubular fitment 3 for attaching or for securing the faucet 2 to the lavatory member 11. For example, the tubular fitment 3 includes an elongate shank 30 having a first end 31 for engaging into the chamber 22 of the faucet 2, and having one or more gaskets or sealing rings 32 engaged onto the first end 31 thereof, and engaged between the faucet 2 and the control shank 23, for making a water tight seal between the faucet 2 and the shank 30. The shank 30 includes a peripheral rib 33 extended radially and outwardly therefrom, for engaging with the faucet 2, and thus for anchoring and securing the shank 30 to the faucet 2 (FIGS. 1, 6).

The shank 30 further includes a peripheral flange 34 extended radially and outwardly therefrom, such as extended from a middle portion 35 thereof, and spaced away from the peripheral rib 33 thereof, for engaging with the base member 21 of the faucet 2, or for directly engaging with or attaching onto the lavatory member 11, and thus for anchoring and securing the shank 30 to the faucet 2 and/or to the lavatory member 11. The shank 30 further includes an outer thread 36 formed or provided on the middle portion 35 thereof, and one or more peripheral grooves 37 formed in the other end 38 thereof, for receiving one or more gaskets or sealing rings 39 therein.

The tubular fitment 3 further includes a pipe 40 having a bore 41 formed therein for receiving the other end 38 and/or the middle portion 35 of the shank 30, and having an inner thread 42 formed in one end 43 thereof, for threading with the outer thread 36 of the shank 30, and thus for engaging with and for securing or attaching the pipe 40 onto the shank 30. It is preferable that the pipe 40 includes a peripheral flap 44 extended radially and outwardly from the one end 43 thereof, for engaging with the lavatory member 11, or for directly engaging with or attaching onto the faucet 2, and includes an enlarged chamber 45 formed in the other end thereof and having an inner diameter greater than that of the bore 41 thereof, for forming a peripheral shoulder 46 therein.

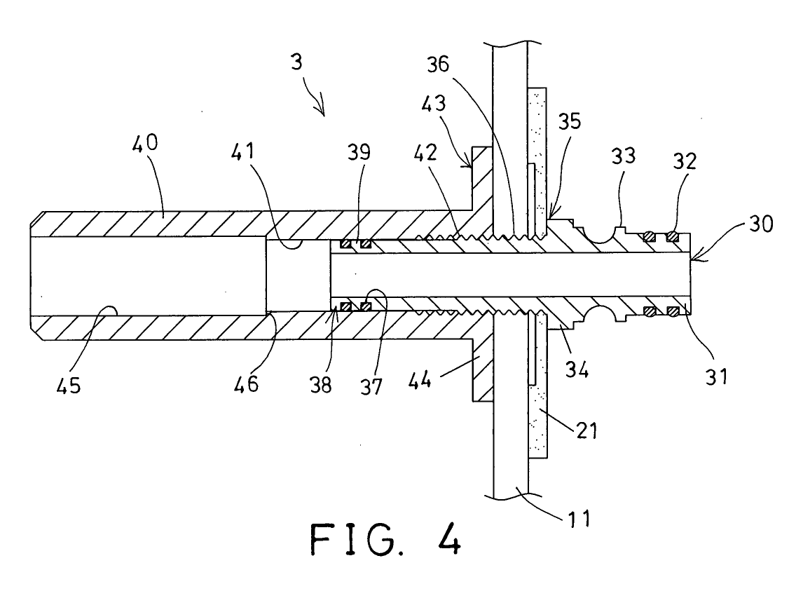

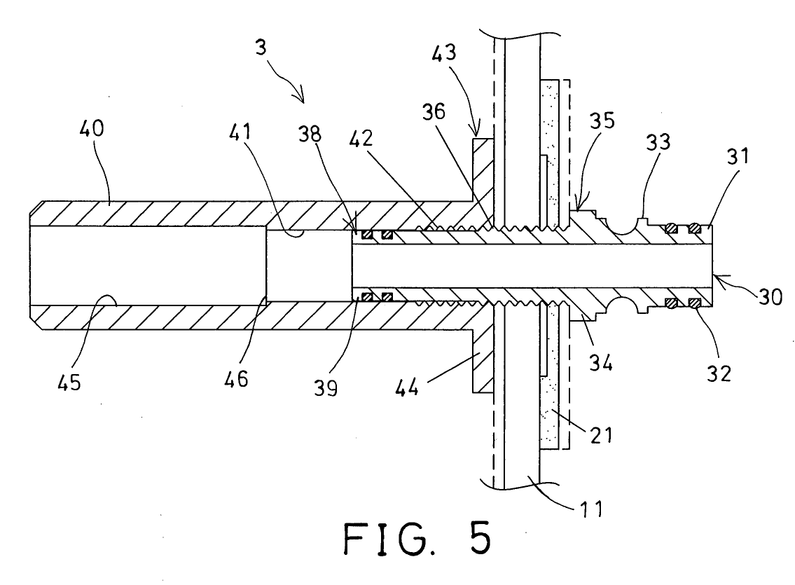

In operation, as shown in FIGS. 4 and 5, the first end 31 of the shank 30 may be engaged into the chamber 22 of the faucet 2, and anchored or secured to the faucet 2, and the peripheral flange 34 of the shank 30 may be engaged with the base member 21 of the faucet 2, or directly engaged with the lavatory member 11, and the other end 38 of the shank 30 may be extended or engaged out through the base member 21 of the faucet 2 and/or the lavatory member 11. The pipe 40 may then be engaged onto the shank 30, and may have the inner thread 42 threaded with the outer thread 36 of the shank 30, and thus to secure or attach the pipe 40 onto the shank 30. The gaskets or sealing rings 39 disposed on the other end 38 of the shank 30 may be engaged with the pipe 40, for making a water tight seal between the shank 30 and the pipe 40.

It is to be noted that the peripheral rib 33 of the shank 30 may be engaged with the faucet 2, to anchor and secure the shank 30 to the faucet 2, and the peripheral flange 34 of the shank 30 may be engaged with the base member 21 of the faucet 2, or directly engaged with the lavatory member 11, to anchor and secure the shank 30 to the faucet 2 and/or to the lavatory member 11. The faucet 2 may thus be easily and readily secured to the lavatory member 11 having different heights or thicknesses or depths, as shown in FIGS. 4 and 5.

As shown in FIG. 6, a valve member 50 may further be provided and attached to the pipe 40, for distributing the water, or for coupling to various lavatory facilities, such as sprayer guns, shower heads, etc.

Accordingly, the tubular fitment for lavatory facilities in accordance with the present invention may be provided for readily attached to the lavatory facilities having different heights or thicknesses or depths.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A lavatory facility comprising:
a lavatory member,
a faucet for attaching to said lavatory member, said faucet including a base member for engaging onto said lavatory member, and including a chamber formed therein,
a tubular fitment for attaching said faucet to said lavatory member, and including an elongate shank having a first end for engaging into said chamber of said faucet, and having at least one sealing ring engaged onto said first end thereof, and engaged between said faucet and said control shank, for making a water tight seal between said faucet and said shank, said shank including a peripheral rib extended radially and outwardly therefrom, for engaging with said faucet, and for anchoring said shank to said faucet,
said shank including a peripheral flange extended radially and outwardly therefrom, and spaced away from said peripheral rib thereof, for engaging with said base member of said faucet, and for anchoring said shank to said faucet and said lavatory member, said shank including an outer thread formed thereon and including a second end having at least one sealing ring engaged thereon, and
a pipe including a bore formed therein for receiving said second end of said shank, and including a first end having an inner thread formed therein, for threading with said outer thread of said shank, and for securing said pipe to said shank.

2. The lavatory facility as claimed in claim 1, wherein said pipe includes a peripheral flap extended radially and outwardly from said first end thereof, for engaging with said lavatory member.

3. The lavatory facility as claimed in claim 1, wherein said faucet includes a control shank slidably engaged through said chamber thereof, and a sealing ring engaged between said faucet and said control shank, for making a water tight seal between said faucet and said control shank.
